(19) United States
(12) Patent Application Publication
(10) Pub. No.: US 2026/0293987 A1
(43) Pub. Date: Oct. 1, 2026

(54) Heating Apparatus for Generating Aerosol

(71) Applicant: Zhou Chen, Shenzhen (CN)

(72) Inventor: Zhou Chen, Shenzhen (CN)

(21) Appl. No.: 19/179,496

(22) Filed: Apr. 15, 2025

(30) Foreign Application Priority Data
Apr. 1, 2025 (CN) 202520595989.9

(51) Int. Cl. A24F 40/465; A24F 7/00; A24F 40/10; A24F 40/20; A24F 40/30; A24F 40/485; H05B 3/06

(52) U.S. Cl. CPC A24F 40/465; A24F 7/00; A24F 40/10; A24F 40/20; A24F 40/30; A24F 40/485; H05B 3/06

(57) ABSTRACT

A heating apparatus for generating aerosol, comprising a housing and a mouthpiece assembly detachably arranged at a top of the housing, wherein the housing comprises an accommodating cavity, a heating assembly, and a heating barrel cavity; a top of the accommodating cavity is provided with an insertion port for inserting aerosol, and a bottom thereof is connected to the heating assembly via a heating element connecting bracket; a bottom of the heating assembly is connected to a ventilation bottom cover; the housing is further provided with a power module electrically connected to the heating assembly and a heating barrel to supply power. The invention uses multi-stage combined isolated heating to heat tobacco sections of a cigarette separately. When the cigarette is more than half heated, the heating is stopped and the next section is directly heated, which ensures that each section of tobacco is not overheated.

### TECHNICAL FIELD

The invention relates to the technical field of aerosols, in particular to a heating apparatus for generating aerosol.

### BACKGROUND ART

Existing aerosol heating apparatuses have single functions, and multifunctional heating apparatuses often require different accessories, which is inconvenient for users to use. In addition, they also have the following disadvantages.

(1) When the existing HNB solid-state cigarettes are heated, the smoke taste is inconsistent. In particular, the taste of the smoke in the second half becomes very bad due to excessive heating over time, and the puffing time is too short.

(2) The existing liquid cigarette cartridges are heated and atomized by direct heating of the heating wire. In order to achieve heavy smoke, the temperature of the heating wire is too high, and heavy metals and other harmful substances increase during atomization. In addition, the existing disposable cigarette cartridges are made of plastic, hardware and other shells, which are difficult to recycle and have a great impact on the environment. At the same time, because the cigarette cartridges are made of plastic, hardware and other shells and electrodes, heating wires, the oil capacity is usually large due to cost considerations, and it is not easy to achieve a small quantitative dose. For people who want to quit smoking, due to the lack of control over the amount of smoke, it is easy to become dependent on such electronic cigarettes and fail to achieve the purpose of quitting smoking. At the same time, the appearance of the existing liquid cigarette cartridges dispels people's vigilance, and they think that electronic cigarettes are not real cigarettes and are harmless. At the same time, the fruit flavors launched by merchants can easily make teenagers who have never smoked become addicted to such electronic cigarettes in pursuit of fashion or out of curiosity.

(3) When the existing barrel-shaped heating assemblies heat filamentary or granular products, it is difficult to remove the tobacco residue after heating due to the barrel-shaped structure at the bottom. At the same time, in order to facilitate the removal of tobacco residue, the barrel capacity cannot be made too large or too deep, which affects the amount of smoke; the suction nozzle is too close to the barrel-shaped heating structure, and the mouthpiece of the heating apparatus will burn the mouth when heating and inhaling. In addition, the smoke will also burn the mouth because the airway through which it flows is too short. The heating position of the heating apparatus for heating filamentary or granular products is seriously hot, affecting the user experience.

(4) When existing barrel-shaped or bowl-shaped heating assemblies heat paste or oil products, the air intake enters from the side, and the smoke below the side air holes cannot be completely removed. In addition, during the heating process, if the product is tilted at too large an angle, the oil will easily flow into the air holes or flow out of the shell.

### SUMMARY OF THE INVENTION

In order to solve the above technical problems, the technical solution provided by the invention is: a heating apparatus for generating aerosol, comprising a housing and a mouthpiece assembly detachably arranged at a top of the housing, wherein the housing comprises an accommodating cavity, a heating assembly, and a heating barrel cavity; a top of the accommodating cavity is provided with an insertion port for inserting aerosol, and a bottom thereof is connected to the heating assembly via a heating element connecting bracket; a bottom of the heating assembly is connected to a ventilation bottom cover; the housing is further provided with a power module electrically connected to the heating assembly and a heating barrel to supply power;
the heating assembly comprises multiple first heating element tubes, wherein the first heating element tubes are spaced apart and connected via isolation connectors; the bottommost first heating element tube is connected to a second heating element tube via an aerosol limiting bracket; a top of the second heating element tube is provided with a detachable ash baffle; the first heating element tubes and the second heating element tube are coaxially surrounded by an outer thermal conductive tube with intervals;
the heating barrel cavity is provided with a heating barrel, which is arranged adjacent to the accommodating cavity and is communicated with the accommodating cavity via a ventilation channel located in the mouthpiece assembly;
the mouthpiece assembly comprises a sealing plate covering an upper part of the housing and a mouthpiece body arranged on the sealing plate; the sealing plate comprises an intake cavity connected to the accommodating cavity and an inhalation wall connected to the mouthpiece body and extending into the heating barrel; the inhalation wall is surrounded by intake protrusions communicating with the ventilation channel and the heating barrel; external air enters the heating assembly and the accommodating cavity in sequence through a bottom ventilation assembly, and passes through the ventilation channel and intake protrusions into the heating barrel, so that the air forms a U shape to bypass a part of the inhalation wall inserting into the heating barrel, and finally enters the user's mouth through an inner cavity of the inhalation wall and the mouthpiece body.

In some embodiments, the isolation connector comprises a first connecting ring spaced from outer walls of the first heating element tubes; both ends of the first connecting ring are provided with first positioning rings inwardly contacting outer walls of adjacent first heating element tubes, and a first bearing ring is provided between the first positioning rings to abut end faces of adjacent first heating element tubes.

In some embodiments, the aerosol limiting bracket comprises a second connecting ring spaced from an outer wall of the first heating element tube; a bottom of the second connecting ring is provided with a limiting ring inwardly; the second connecting ring and limiting ring are provided with second positioning rings contacting the outer wall of the first heating element tube and inner wall of the second heating element tube, respectively, and a second bearing ring abutting end faces of the first heating element tube and the second heating element tube; the limiting ring is provided with a limiting protrusion on its inner wall and a ventilation baffle below the limiting protrusion.

In some embodiments, an inner diameter of the limiting protrusion is smaller than an inner diameter of the first heating element tube, so that the aerosol is inserted from the insertion port of the accommodating cavity to the limiting protrusion.

In some embodiments, the first heating element tube is an HNB (Heat-Not-Burn) heating element or vaporization cartridge chamber with a hollow structure.

In some embodiments, the second heating element tube is a filamentary or granular heating element.

In some embodiments, the outer thermal conductive tube is helically wound with a heating wire.

In some embodiments, the mouthpiece assembly and ventilation bottom cover are detachably magnetically connected to the housing through magnetic connection assemblies; a bottom of the second heating element tube is provided with a bottom connecting frame; the ventilation bottom cover comprises a ventilation cavity inserted into the bottom connecting frame, and a bottom of the ventilation cavity is connected to a ventilation hole; a convex-shaped ash baffle is detachably clamped between the ventilation cavity and bottom connecting frame.

In some embodiments, the aerosol is an HNB solid tobacco stick comprising a metal tube with a tobacco tube section, a high-temperature cotton section, and multiple tobacco sections arranged sequentially from top to bottom; the tobacco tube section, high-temperature cotton section, and multiple tobacco sections are separated by hollow sections or isolation sections; lengths of the tobacco tube section, high-temperature cotton section, and multiple tobacco sections correspond to the first heating element tubes, and lengths of the hollow sections or isolation sections correspond to the isolation connectors.

In some embodiments, the aerosol is a liquid tobacco stick comprising a metal tube with a tobacco tube section, a heat-insulating ceramic section, a porous ceramic rod section, and a filter section arranged sequentially from top to bottom; the porous ceramic rod section is provided with a blind hole inwardly from the filter section, and a plurality of ventilation channels penetrating the porous ceramic rod section are provided on a periphery of the blind hole; a sealing silicone plug is provided at an end of the blind hole.

The advantages of the invention over the prior art are as follows: (1) the invention can avoid the problem of smoke scalding when the HNB cigarette cartridge is heated and inhaled, or when the filamentous or granular products are heated and inhaled, by designing a longer airway.

(2) The invention provides boss-shaped air inlet holes, so that when the product is tilted at a large angle or the product falls over, the air will not easily bypass the boss holes and enter the interior of the product, the exterior of the shell, or the interior of the filter.

(3) The invention can evenly dissipate the overflow heat from heating a single section by providing a peripheral heat conduction pipe, thereby avoiding the problem of local overheating of the product.

(4) The invention uses multi-stage combined isolated heating to heat tobacco sections of a cigarette separately. When the cigarette is more than half heated, the heating is stopped and the next section is directly heated, which ensures that each section of tobacco is not overheated, so as to achieve the purpose of achieving a consistent smoke taste when the solid cigarette cartridge is heated. At the same time, the smoking time of the cigarette cartridge is extended.

### BRIEF DESCRIPTION OF THE INVENTION

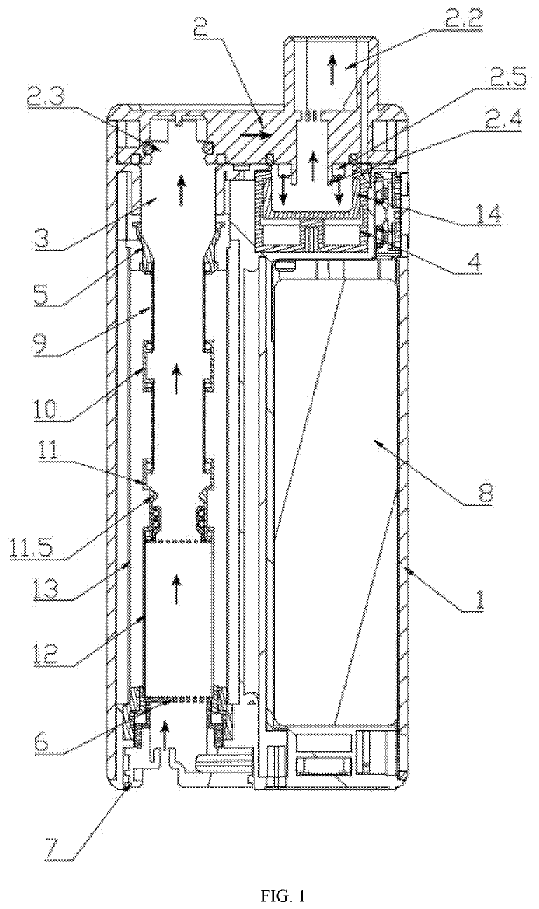

FIG. 1 is a schematic cross-sectional view of Embodiment 1 of the heating apparatus for generating aerosol according to the invention.

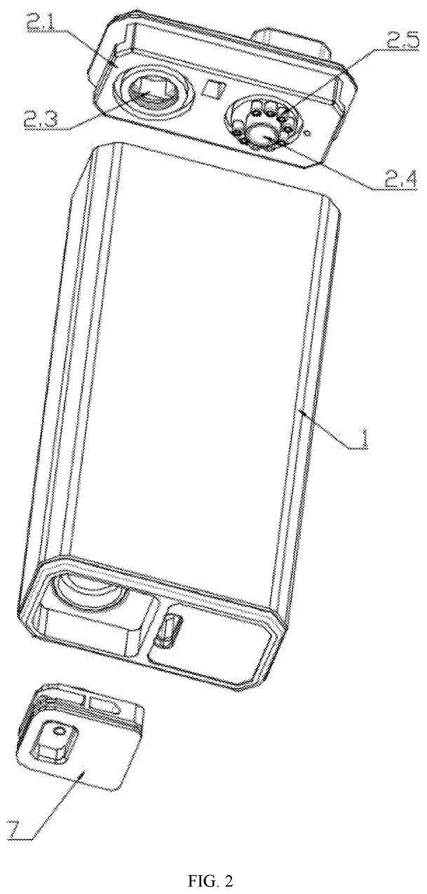

FIG. 2 is a schematic diagram of the bottom structure of a mouthpiece assembly in Embodiment 1 of the heating apparatus for generating aerosol according to the invention.

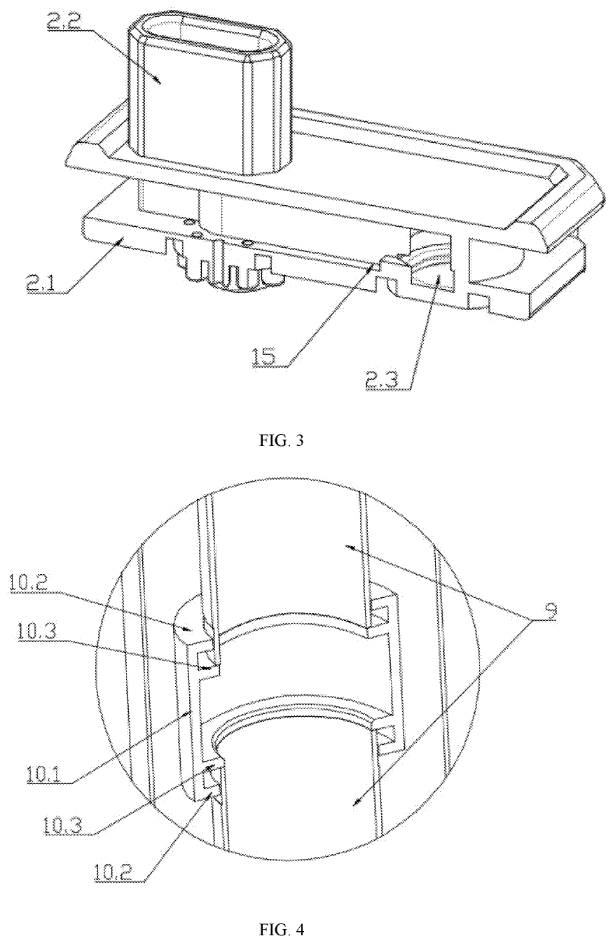

FIG. 3 is a schematic diagram of the structure of the ventilation channel of the mouthpiece assembly in Embodiment 1 of the heating apparatus for generating aerosol according to the invention.

FIG. 4 is a schematic diagram of the cross-sectional structure of the isolation connector in Embodiment 1 of the heating apparatus for generating aerosol according to the invention.

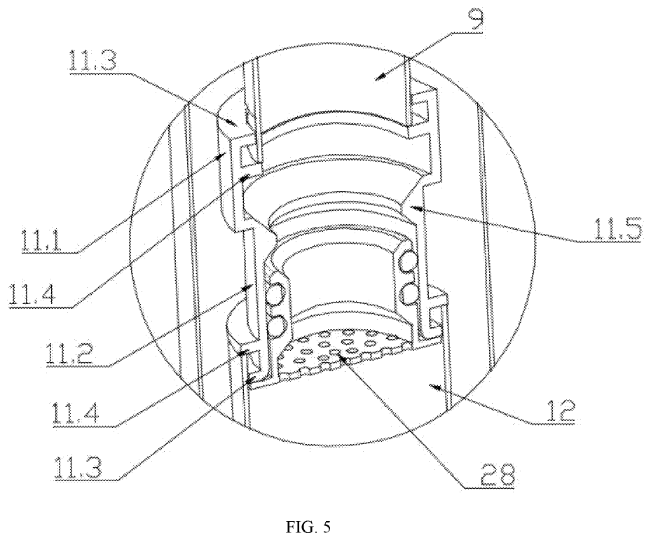

FIG. 5 is a schematic diagram of the cross-sectional structure of the aerosol limiting bracket in Embodiment 1 of the heating apparatus for generating aerosol according to the invention.

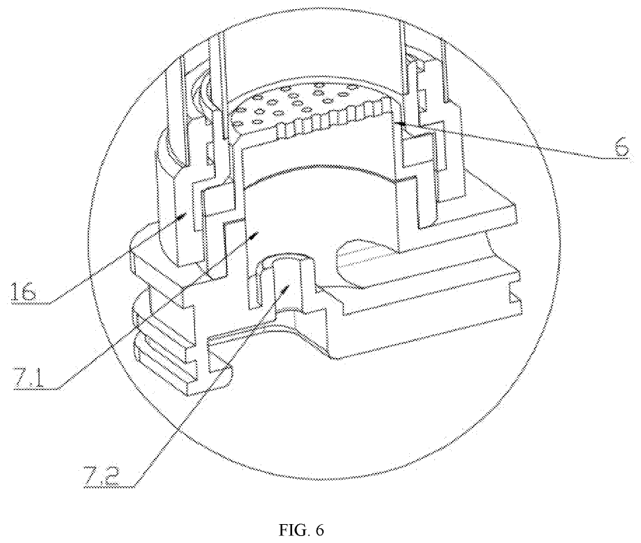

FIG. 6 is a schematic diagram of the cross-sectional structure of the ash baffle in Embodiment 1 of the heating apparatus for generating aerosol according to the invention.

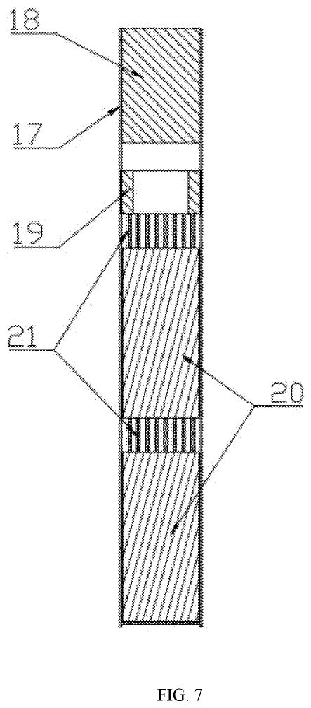

FIG. 7 is a schematic cross-sectional view of Embodiment 2 of the heating apparatus for generating aerosol according to the invention.

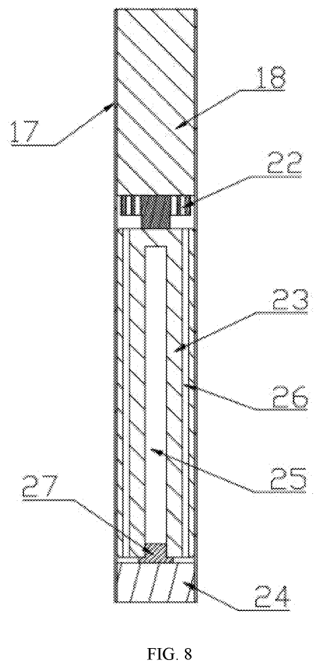

FIG. 8 is a schematic cross-sectional view of Embodiment 4 of the heating apparatus for generating aerosol according to the invention.

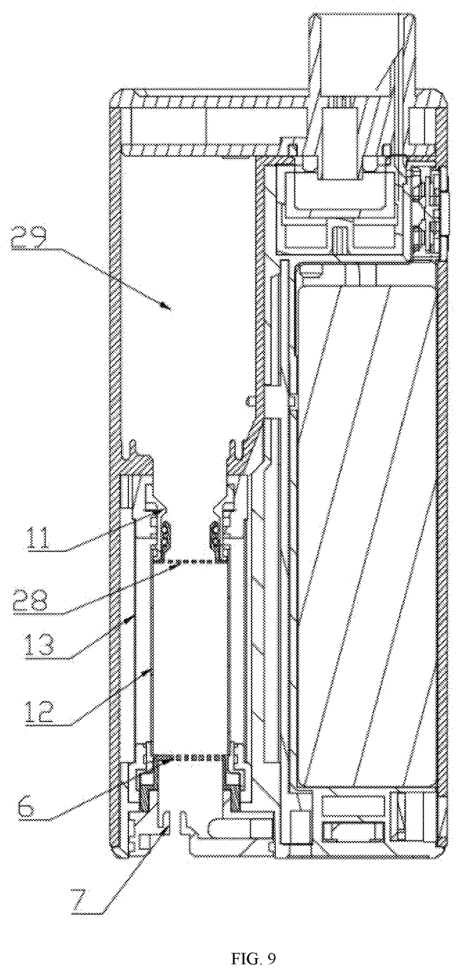

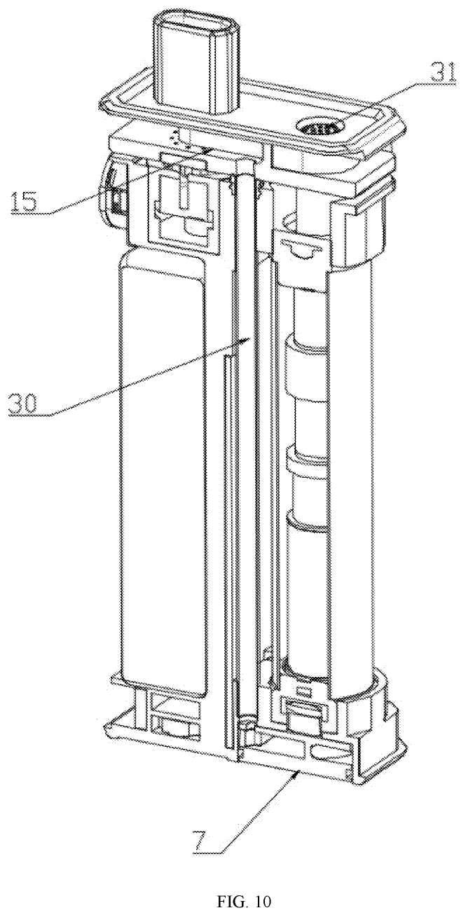

FIG. 9 is a schematic cross-sectional view of Embodiment 5 of the heating apparatus for generating aerosol according to the invention.

FIG. 10 is a schematic cross-sectional view of Embodiment 6 of the heating apparatus for generating aerosol according to the invention.

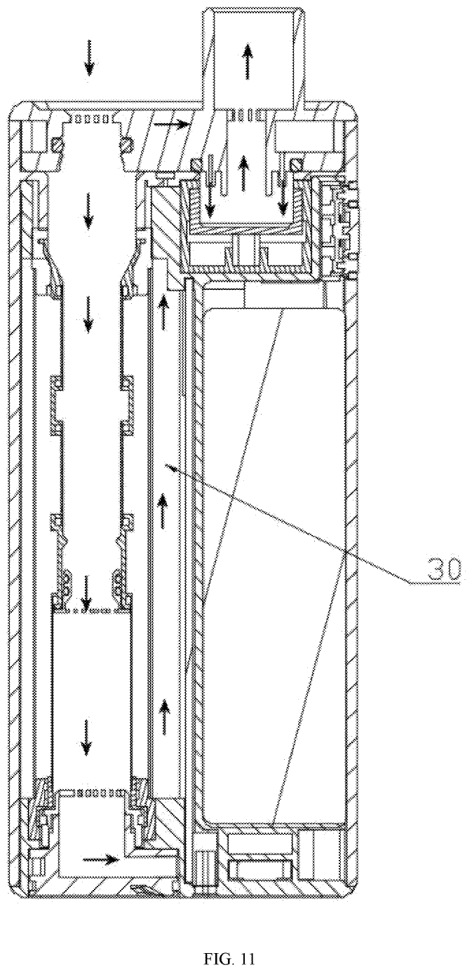

FIG. 11 is a schematic diagram of gas flow in Embodiment 6 of the heating apparatus for generating aerosol according to the invention.

### SPECIFIC EMBODIMENT OF THE INVENTION

In order to make the objectives, technical solutions, and advantages of the embodiments of the invention clearer, the technical solutions in the embodiments of the invention will be described clearly and completely hereinafter with reference to the drawings in the embodiments of the invention. Obviously, the described embodiments are part of the embodiments of the invention, rather than all of the embodiments. The components of the embodiments of the invention generally described and illustrated in the drawings herein may be arranged and designed in various different configurations.

### Embodiment 1

With reference to FIGS. 1-6, a heating apparatus for generating aerosol, comprising a housing 1 and a mouthpiece assembly 2 detachably arranged at a top of the housing 1, wherein the housing 1 comprises an accommodating cavity 3 and a heating barrel cavity 4; a top of the accommodating cavity 3 is provided with an insertion port for inserting aerosol, and a bottom thereof is connected to the heating assembly via a heating element connecting bracket 5; a bottom of the heating assembly is connected to a ventilation bottom cover 7 via an ash baffle 6; the housing 1 is further provided with a power module 8 electrically connected to the heating assembly and a heating barrel to supply power;
the heating assembly comprises multiple first heating element tubes 9, wherein the first heating element tubes 9 are spaced apart and connected via isolation connectors 10; the bottommost first heating element tube 9 is connected to a second heating element tube 12 via an aerosol limiting bracket 11; the first heating element tubes 9 and the second heating element tube 12 are coaxially surrounded by an outer thermal conductive tube with intervals 13; in the embodiment, the first heating element tube 9 is an HNB (Heat-Not-Burn) heating element; the second heating element tube 12 is a filamentary or granular heating element.

The heating barrel cavity 4 is provided with a heating barrel 14, which is arranged adjacent to the accommodating cavity 3 and is communicated with the accommodating cavity 3 via a ventilation channel 15 located in the mouthpiece assembly 2; the mouthpiece assembly 2 comprises a sealing plate 2.1 covering an upper part of the housing 1 and a mouthpiece body 2.2 arranged on the sealing plate 2.1; the sealing plate 2.1 comprises an intake cavity 2.3 connected to the accommodating cavity 3 and an inhalation wall 2.4 connected to the mouthpiece body 2.2 and extending into the heating barrel 14; the inhalation wall 2.4 is surrounded by intake protrusions 2.5 communicating with the ventilation channel 2.5 and the heating barrel 14; external air enters the heating assembly and the accommodating cavity 3 in sequence through a bottom ventilation assembly, and passes through the ventilation channel 15 and intake protrusions 2.5 into the heating barrel 14, so that the air forms a U shape to bypass a part of the inhalation wall 2.4 inserting into the heating barrel 14, and finally enters the user's mouth through an inner cavity of the inhalation wall 2.4 and the mouthpiece body 2.2.

In the embodiment, paste and oil substances are stored in the heating barrel. The design of the inhalation wall and the intake protrusions can take away most of the smoke generated by the heating assembly of the bowl-shaped paste and oil substances. The intake hole is designed as a boss hole, and when the product is tilted at a large angle or the product falls over, it will not easily bypass the boss hole to enter the inside of the product or the outside of the housing or the inside of the filter. In addition, because the air channel design in the embodiment is relatively long, the problem of hot smoke when the aerosol is heated and inhaled and the filamentary or granular products are heated and inhaled can be avoided. At the same time, the upper HNB heating element and the lower filamentary or granular heating element are designed to be aligned in a vertical row, and the periphery is uniformly designed with an outer thermal conductive tube, which can evenly dissipate the overflow heat of the individual heating sections to avoid the problem of local overheating of the product.

Specifically, the isolation connector 10 comprises a first connecting ring 10.1 spaced from outer walls of the first heating element tubes 9; both ends of the first connecting ring 10.1 are provided with first positioning rings 10.2 inwardly contacting outer walls of adjacent first heating element tubes 9, and a first bearing ring 10.3 is provided between the first positioning rings 10.2 to abut end faces of adjacent first heating element tubes 9.

In the embodiment, the first heating element tubes are isolated and heated through a multi-section combination. The heating element tubes are connected by isolation connectors made of isolation material, and the inner wall of the isolation connector and the aerosol wall are designed to avoid air, and do not participate in the heating of the cigarette cartridge; in the prior art, most of the multi-section heating tubes are designed as an integrated design, and the temperature rises slowly and the power consumption is large when a single section is heated. When the tobacco is heated in a single section and enters the next section, the heating tube is an integrated design, and the tobacco is not separated from the section. The intersection position will still be repeatedly overheated, affecting the taste of the smoke, and the design of the embodiment can avoid the above shortcomings.

Specifically, the aerosol limiting bracket 11 comprises a second connecting ring 11.1 spaced from an outer wall of the first heating element tube 9; a bottom of the second connecting ring 11.1 is provided with a limiting ring 11.2 inwardly; the second connecting ring 11.1 and limiting ring 11.2 are provided with second positioning rings 11.3 contacting the outer wall of the first heating element tube 9 and inner wall of the second heating element tube 12, respectively, and a second bearing ring 11.4 abutting end faces of the first heating element tube 9 and the second heating element tube 12; the limiting ring 11.2 is provided with a limiting protrusion 11.5 on its inner wall and a ventilation baffle 28 below the limiting protrusion 11.5; an inner diameter of the limiting protrusion 11.5 is smaller than an inner diameter of the first heating element tube 9, so that the aerosol is inserted from the insertion port of the accommodating cavity 3 to the limiting protrusion 11.5.

In the embodiment, the ventilation baffle is detachably connected to the limiting ring. Since the ventilation baffle 28 and the first heating element tubes are designed to be aligned in a vertical row, when cleaning the tobacco residue, it is only necessary to push out the ventilation baffle with a cleaning brush and bring the tobacco residue out of the housing at the same time. At the same time, if the difficulty of removing and cleaning the tobacco residue is not considered, the heating element tubes can be lengthened to more than 10 mm, so that the tobacco capacity can be more than twice as much as before.

The mouthpiece assembly 2 and ventilation bottom cover 7 are detachably magnetically connected to the housing 1 through magnetic connection assemblies; a bottom of the second heating element tube 12 is provided with a bottom connecting frame 16; the ventilation bottom cover 7 comprises a ventilation cavity 7.1 inserted into the bottom connecting frame 16, and a bottom of the ventilation cavity 7.1 is connected to a ventilation hole 7.2; a convex-shaped ash baffle is detachably clamped between the ventilation cavity 7.1 and bottom connecting frame 16.

### Embodiment 2

With reference to FIG. 7, in the embodiment, the aerosol is an HNB solid tobacco stick comprising a metal tube 17 with a tobacco tube section 18, a high-temperature cotton section 19, and multiple tobacco sections 20 arranged sequentially from top to bottom; the tobacco tube section 18, high-temperature cotton section 19, and multiple tobacco sections 20 are separated by hollow sections or isolation sections 21; lengths of the tobacco tube section 18, high-temperature cotton section 19, and multiple tobacco sections 20 correspond to the first heating element tubes 9, and lengths of the hollow sections or isolation sections 21 correspond to the isolation connectors 10.

In the specific implementation of the embodiment, the tobacco sections of the cigarette can be heated separately, and the heating is stopped when the cigarette is heated to more than half, and the next section is directly heated. It is ensured that each section of tobacco is not overheated, so as to achieve the purpose of consistent smoke taste when the HNB solid-state cigarette cartridge is heated; and at the same time, the smoking time of the cigarette cartridge is extended.

### Embodiment 3

Compared with Embodiment 2, in the embodiment, the outer thermal conductive tube is helically wound with a heating wire. In the specific implementation of the embodiment, the metal tube of the cigarette with the heat-conducting metal tube is directly heated by magnetic field induction.

### Embodiment 4

With reference to FIG. 8, in the embodiment, the aerosol is a liquid tobacco stick comprising a metal tube 17 with a tobacco tube section 18, a heat-insulating ceramic section 22, a porous ceramic rod section 23, and a filter section 24 arranged sequentially from top to bottom; the porous ceramic rod section 23 is provided with a blind hole 25 inwardly from the filter section 24, and a plurality of ventilation channels 26 penetrating the porous ceramic rod section 23 are provided on a periphery of the blind hole 25; a sealing silicone plug 27 is provided at an end of the blind hole.

In the specific implementation of the embodiment, the surface of the porous ceramic rod is sealed with glaze, and the blind hole in the middle carries the atomized smoke liquid. The atomized smoke liquid penetrates into various positions of the porous ceramic rod due to the porous characteristics of the ceramic, and does not leak due to the surface tension of the atomized smoke liquid. At the same time, the atomized smoke liquid is not limited to smoke oil, but can also be cell nutrient solution or traditional Chinese medicine solution, etc. At the same time, the appearance and suction method of the liquid cigarette can greatly dispel the curiosity of non-smoking teenagers to smoke electronic cigarettes.

### Embodiment 5

With reference to FIG. 9, compared with Embodiment 1, in the embodiment, the first heating element tube 9 is arranged to be located at an atomizing cartridge cavity 29 with a hollow structure.

### Embodiment 6

With reference to FIGS. 10-11, in some embodiments, an internal ventilation tube 30 connecting the ventilation bottom cover 7 and the ventilation channel 15 can be further provided. At the same time, an external gas inlet hole 31 is provided on a portion of the mouthpiece assembly 2 corresponding to the accommodating cavity 3, so that the external gas enters the heating assembly, the ventilation bottom cover 7, the internal ventilation tube 30 into the ventilation channel 15 in sequence through the external gas inlet hole 31, and then enters the heating barrel cavity 4 through the intake protrusions 2.5, so that the air forms a U shape to bypass a part of the inhalation wall inserting into the heating barrel, and finally enters the user's mouth through an inner cavity of the inhalation wall and the mouthpiece body.

The invention and the embodiments thereof are described hereinabove, and this description is not restrictive. What is shown in the drawings is only one of the embodiments of the invention, and the actual structure is not limited thereto. All in all, structural methods and embodiments similar to the technical solution without deviating from the purpose of the invention made by those of ordinary skill in the art without creative design shall all fall within the protection scope of the invention.

1. A heating apparatus for generating aerosol, comprising a housing and a mouthpiece assembly detachably arranged at a top of the housing, wherein the housing comprises an accommodating cavity, a heating assembly, and a heating barrel cavity; a top of the accommodating cavity is provided with an insertion port for inserting aerosol, and a bottom thereof is connected to the heating assembly via a heating element connecting bracket; a bottom of the heating assembly is connected to a ventilation bottom cover; the housing is further provided with a power module electrically connected to the heating assembly and a heating barrel to supply power;
the heating assembly comprises multiple first heating element tubes, wherein the first heating element tubes are spaced apart and connected via isolation connectors; the bottommost first heating element tube is connected to a second heating element tube via an aerosol limiting bracket; a top of the second heating element tube is provided with a detachable ash baffle; the first heating element tubes and the second heating element tube are coaxially surrounded by an outer thermal conductive tube with intervals;
the heating barrel cavity is provided with a heating barrel, which is arranged adjacent to the accommodating cavity and is communicated with the accommodating cavity via a ventilation channel located in the mouthpiece assembly;
the mouthpiece assembly comprises a sealing plate covering an upper part of the housing and a mouthpiece body arranged on the sealing plate; the sealing plate comprises an intake cavity connected to the accommodating cavity and an inhalation wall connected to the mouthpiece body and extending into the heating barrel; the inhalation wall is surrounded by intake protrusions communicating with the ventilation channel and the heating barrel; external air enters the heating assembly and the accommodating cavity in sequence through a bottom ventilation assembly, and passes through the ventilation channel and intake protrusions into the heating barrel, so that the air forms a U shape to bypass a part of the inhalation wall inserting into the heating barrel, and finally enters the user's mouth through an inner cavity of the inhalation wall and the mouthpiece body.

2. The heating apparatus for generating aerosol of claim 1, wherein the isolation connector comprises a first connecting ring spaced from outer walls of the first heating element tubes; both ends of the first connecting ring are provided with first positioning rings inwardly contacting outer walls of adjacent first heating element tubes, and a first bearing ring is provided between the first positioning rings to abut end faces of adjacent first heating element tubes.

3. The heating apparatus for generating aerosol of claim 1, wherein the aerosol limiting bracket comprises a second connecting ring spaced from an outer wall of the first heating element tube; a bottom of the second connecting ring is provided with a limiting ring inwardly; the second connecting ring and limiting ring are provided with second positioning rings contacting the outer wall of the first heating element tube and inner wall of the second heating element tube, respectively, and a second bearing ring abutting end faces of the first heating element tube and the second heating element tube; the limiting ring is provided with a limiting protrusion on its inner wall and a ventilation baffle below the limiting protrusion.

4. The heating apparatus for generating aerosol of claim 3, wherein an inner diameter of the limiting protrusion is smaller than an inner diameter of the first heating element tube, so that the aerosol is inserted from the insertion port of the accommodating cavity to the limiting protrusion.

5. The heating apparatus for generating aerosol of claim 2, wherein the first heating element tube is an HNB (Heat-Not-Burn) heating element or vaporization cartridge chamber with a hollow structure.

6. The heating apparatus for generating aerosol of claim 3, wherein the second heating element tube is a filamentary or granular heating element.

7. The heating apparatus for generating aerosol of claim 1, wherein the outer thermal conductive tube is helically wound with a heating wire.

8. The heating apparatus for generating aerosol of claim 1, wherein the mouthpiece assembly and ventilation bottom cover are detachably magnetically connected to the housing through magnetic connection assemblies; a bottom of the second heating element tube is provided with a bottom connecting frame; the ventilation bottom cover comprises a ventilation cavity inserted into the bottom connecting frame, and a bottom of the ventilation cavity is connected to a ventilation hole; a convex-shaped ash baffle is detachably clamped between the ventilation cavity and bottom connecting frame.

9. The heating apparatus for generating aerosol of claim 1, wherein the aerosol is an HNB solid tobacco stick comprising a metal tube with a tobacco tube section, a high-temperature cotton section, and multiple tobacco sections arranged sequentially from top to bottom; the tobacco tube section, high-temperature cotton section, and multiple tobacco sections are separated by hollow sections or isolation sections; lengths of the tobacco tube section, high-temperature cotton section, and multiple tobacco sections correspond to the first heating element tubes, and lengths of the hollow sections or isolation sections correspond to the isolation connectors.

10. The heating apparatus for generating aerosol of claim 1, wherein the aerosol is a liquid tobacco stick comprising a metal tube with a tobacco tube section, a heat-insulating ceramic section, a porous ceramic rod section, and a filter section arranged sequentially from top to bottom; the porous ceramic rod section is provided with a blind hole inwardly from the filter section, and a plurality of ventilation channels penetrating the porous ceramic rod section are provided on a periphery of the blind hole; a sealing silicone plug is provided at an end of the blind hole.
